(19) United States
(12) Patent Application Publication
(10) Pub. No.: US 2006/0022831 A1
(43) Pub. Date: Feb. 2, 2006

(54) Magnetostrictive device, actuator, sensor, driving method of actuator and sensing method by sensor

(75) Inventor: Teruo Mori, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK CORPORATION

(21) Appl. No.: 11/157,339

(22) Filed: Jun. 20, 2005

(30) Foreign Application Priority Data
Jul. 27, 2004 (JP) 2004-219212
Jul. 27, 2004 (JP) 2004-219213

(51) Int. Cl. G08B 13/14

(52) U.S. Cl. 340/572.6

(57) ABSTRACT

Magnetostrictive devices, such as an actuator and a sensor, having a reduced hysteresis characteristic are provided. An actuator 10 includes a cylindrical magnetostrictive element 1 expanding or contracting in the axial direction by application of a driving magnetic field; an electromagnetic coil 2 placed on the outer surface side of the magnetostrictive element 1 and for applying the driving magnetic field; and a polar-anisotropic cylindrical magnet 3 placed on the inner surface side of the magnetostrictive element 1 and for applying a magnetic field to the magnetostrictive element 1. The polar-anisotropic cylindrical magnet 3 applies a magnetic field in the peripheral direction of the magnetostrictive element 1. The magnetic field orthogonally crosses the driving magnetic field applied to the magnetostrictive element 1 by the electromagnetic coil 2.

### BACKGROUND OF THE INVENTION

1. Field of the Invention

The present invention relates to a device using magnetostrictive elements such as an actuator, an oscillator and a sensor, and particularly to a magnetostrictive device with reduced hysteresis of a displacement or reduced hysteresis of an inductance.

2. Description of the Related Art

A phenomenon in which the dimension of a ferromagnetic material is changed when the ferromagnetic material is magnetized is called magnetostriction, and a material causing such a phenomenon is called a magnetostrictive material. A saturated magnetostriction constant, i.e. a saturated amount of change by magnetostriction, has generally a value of 10⁻⁵ to 10⁻⁶, and a magnetostrictive material having a high saturated magnetostriction constant is also called a giant magnetostrictive material, and is widely used for actuators, oscillators, filters, sensors and the like. For example, a magnetostrictive device in which the number of coils is reduced and the structure is simplified is disclosed in Japanese Patent Laid-Open No. 10-84596. This magnetostrictive device is one including at least one magnetostrictive member, a permanent magnet and a coil, wherein the magnetostrictive member has both ends in opposite directions restrained, and is given an external force or has an end portion for outputting a magnetostriction displacement on at least one of both ends, the permanent magnet applies a bias magnetic field in a direction of both ends or a bias magnetic field in a direction around a main axis situated along the direction of both ends, and the coil is coupled to the magnetostrictive member in a relation in which the direction of a roll axis crosses the direction of the bias magnetic field. The actuator in this magnetostrictive device outputs a torsion displacement.

When the giant magnetostrictive material is deformed under a pressure of mechanical compression, elongation, torsion or the like, its magnetic properties, specifically its permeability is changed depending on the speed and the size of the force. By detecting this change in permeability as a change in inductance of the coil, the magnitude of the pressure can be measured.

As a pressure sensor utilizing such a principle, those disclosed in Japanese Patent Laid-Open No. 8-320337, Japanese Patent Laid-Open No. 2000-266621 and Japanese Patent Laid-Open No. 2003-156382 are known.

Among them, Japanese Patent Laid-Open No. 8-320337 proposes use of a magnetostrictive element having a cavity portion formed across the entire length along the axial direction for the purpose of suppressing an eddy current associated with a change in permeability of the magnetostrictive element.

Japanese Patent Laid-Open No. 2000-266621 proposes provision of a permanent magnet applying a bias magnetic field substantially in parallel with the direction of weight of the magnetostrictive element for the purpose of reducing a temperature characteristic of the change in inductance of the coil.

A linear actuator using a magnetostrictive element utilizes a displacement being generated by the Joule effect when a magnetic field is applied in a direction parallel to a driving direction. However, the actuator using a magnetostrictive element has a hysteresis characteristic present in its displacement due to its operation principle. The hysteresis characteristic refers to a phenomenon in which the state of an object does not defined just by conditions under which it is currently situated, but depends on the history of states which the object have traced before.

Presence of the hysteresis characteristic compromises positioning accuracy in the actuator. Namely, if no hysteresis characteristic is present, high positioning accuracy can be obtained because the relation between a displacement command value and a displacement (position) is defined on a one-to-one basis. In contrast to this, if the hysteresis characteristic is present, a displacement trace becomes nonlinear, and the relation between a displacement command value and a displacement (position) is not uniquely defined, resulting in poor positioning accuracy.

For the magnetostrictive sensor, similarly, the relation between the magnitude of a received pressure and a change in inductance of the coil has a hysteresis characteristic. Specifically, an inductance value obtained when the pressure increases is different from an inductance value obtained when the pressure decreases. The hysteresis characteristic compromises the measurement accuracy of the sensor. This has led to proposal of the technique in Japanese Patent Laid-Open No. 2003-156382. Namely, Japanese Patent Laid-Open No. 2003-156382 proposes a pressure sensor having a configuration in which a first coil for detecting an inductance and a second coil for passing an impulse current for removing a hysteresis characteristic of a magnetostrictive element are doubly wound in such a manner as to surround the magnetostrictive element. According to Patent Document 3, by passing an impulse current, the direction of a magnetic moment in the magnetostrictive element is made uniform, and hysteresis is suppressed.

For compensation of the hysteresis characteristic, a method of inputting to a magnetostrictive actuator a command value allowing for a positional deviation resulting from the hysteresis characteristic has been employed. In this case, a circuit including a control program for adding the command value allowing for a positional deviation is required. This control circuit causes a rise in cost of the magnetostrictive actuator. Therefore, it is desired to reduce the hysteresis characteristic of the actuator itself.

The technique regarding a sensor disclosed in Japanese Patent Laid-Open No. 2003-156382 is a technique effective for suppression of the hysteresis characteristic of the inductance, but it is necessary to separately provide a power source supplying impulse currents and a circuit for controlling supply of currents, and this circuit causes a rise in cost of the magnetostrictive sensor. Since an impulse current is supplied, the second coil unavoidably generates heat, and this heat generation may adversely affect measurement accuracy.

The present invention has been made based on such technical problems, and has an object to provide a magnetostrictive device, such as an actuator or sensor, having a reduced hysteresis characteristic. The present invention has another object to provide a driving method of a magnetostrictive actuator capable of reducing the hysteresis characteristic. The present invention has still another object to provide a sensing method by a magnetostrictive sensor capable of reducing the hysteresis characteristic.

### SUMMARY OF THE INVENTION

The present inventors have found that regarding an actuator using the magnetostrictive element, by applying a driving magnetic field for expanding or contracting the magnetostrictive element while applying a magnetic field crossing, or typically orthogonally crossing the driving magnetic field to the magnetostrictive element, a hysteresis characteristic can be reduced, and the linearity of a displacement trace can be improved. The inventors have also found that regarding a sensor using a magnetostrictive element, by applying a magnetic field crossing, or typically orthogonally crossing a direction of expansion or contraction of the magnetostrictive element to the magnetostrictive element, the hysteresis characteristic can be reduced. Namely, the present invention has solved the above described problems by a magnetostrictive device comprising a magnetostrictive element expanding or contracting in the axial direction by application of a magnetic field or by an external pressure, a coil for applying a magnetic field or detecting a change in permeability of the magnetostrictive element according to the expansion or contraction, and magnetic field applying means for applying a magnetic field in a direction crossing the direction of expansion or contraction of the magnetostrictive element.

As a specific configuration of the magnetostrictive device of the present invention, the magnetostrictive element is composed of a cylindrical body having a hollow portion, the coil is placed coaxially with the cylindrical body, and the magnetic field applying means can be composed of a cylindrical permanent magnet placed coaxially with the cylindrical body. In this configuration, it is preferable that the coil is placed around the cylindrical body and the cylindrical permanent magnet is placed in the hollow portion of the cylindrical body. As this cylindrical permanent magnet, a polar-anisotropic permanent magnet may be used.

When magnetostrictive device of the present invention is applied to an actuator, the device preferably comprises a magnetostrictive element expanding or contracting in the axial direction by application of a first magnetic field in a direction parallel to the axial direction, first magnetic field applying means composed of a coil for applying the first magnetic field to the magnetostrictive element, and second magnetic field applying means for applying a second magnetic field in a direction crossing the first magnetic field to the magnetostrictive element. As this second magnetic field applying means, a polar-anisotropic permanent magnet may be used. In this case, the first magnetic field and the second magnetic field substantially orthogonally cross each other. As a further specific configuration, the device can comprise a casing containing the magnetostrictive element, the first magnetic field applying means and the second magnetic field applying means and composed of a ferromagnetic material, and an output end portion for outputting a magnetostriction displacement of the magnetostrictive element and composed of a ferromagnetic material.

When the magnetostrictive device of the present invention is applied to a sensor detecting a pressure, the device preferably comprises a magnetostrictive element expanding or contracting by receiving a pressure in the axial direction, a coil for detecting a change in permeability of the magnetostrictive element according to the expansion or contraction, and magnetic field applying means for applying a magnetic field in a direction crossing a direction of expansion or contraction of the magnetostrictive element to the magnetostrictive element. As this magnetic field applying means, a polar-anisotropic permanent magnet may be used and in this case, the direction of expansion or contraction and the magnetic field applied by the magnetic field applying means substantially orthogonally cross each other. As a further specific configuration, the device can comprise a casing containing the magnetostrictive element, the coil and the second magnetic field applying means and composed of a ferromagnetic material, and a pressure receiving portion given a pressure and composed of a ferromagnetic material.

In the magnetostrictive device of the present invention, a sintered body having a composition expressed by RT_{y} (R represents one or more rare earth metals, T represents one or more transition metals, and y satisfies the requirement of 1<y<4) is preferably used as the magnetostrictive element.

In the magnetostrictive device of the present invention, it is preferable that the cylindrical permanent magnet is composed of an Nd—Fe—B system sintered magnet.

The present invention also provides an actuator comprising a cylindrical magnetostrictive element expanding or contracting in the axial direction by application of a driving magnetic field, an electromagnetic coil placed on the outer surface side of said magnetostrictive element and for applying the driving magnetic field, and polar-anisotropic cylindrical permanent magnet placed on the inner surface side of the magnetostrictive element and for applying a magnetic field to the magnetostrictive element.

In the actuator of the present invention, the polar-anisotropic cylindrical permanent magnet applies a bias magnetic field to the magnetostrictive element in its peripheral direction, and application of such a bias magnetic field can reduce the hysteresis characteristic of a magnetostrictive value in the process of expansion or contraction of the magnetostrictive element.

The present invention also provides a sensor comprising a cylindrical magnetostrictive element expanding or contracting in the axial direction by receiving an external pressure, a coil placed on the outer surface side of the magnetostrictive element and detecting a change in permeability of the magnetostrictive element as a change in inductance, and a polar-anisotropic cylindrical permanent magnet placed on the inner surface side of the magnetostrictive element and for applying a magnetic field to the magnetostrictive element.

In the sensor of the present invention, the polar-anisotropic cylindrical permanent magnet applies a bias magnetic field to the magnetostrictive element in its peripheral direction, and application of such a bias magnetic field can reduce the hysteresis characteristic of an inductance value in the process of expansion or contraction.

An unprecedented new driving method of a magnetostrictive actuator is provided by the magnetostrictive device, especially the actuator, of the present invention. The driving method of the magnetostrictive actuator comprises the steps of (A) expanding or contracting a magnetostrictive element in the axial direction by applying a driving magnetic field to the magnetostrictive element in its axial direction, and (B) applying a bias magnetic field substantially orthogonally crossing the driving magnetic field to the magnetostrictive element in the step (A).

An unprecedented new sensing method by a magnetostrictive sensor is provided by the magnetostrictive device, especially the sensor, of the present invention. The sensing method by the magnetostrictive sensor comprises the steps of (a) detecting a change in permeability of the magnetostrictive element by expansion or contraction of the magnetostrictive element in the axial direction, and (b) applying a bias magnetic field substantially orthogonally crossing the direction of expansion or contraction to the magnetostrictive element in the step (a).

According to the present invention, the hysteresis characteristic of the magnetostrictive device using a magnetostrictive element can be reduced. Thus, an actuator and a driving method of the magnetostrictive actuator capable of reducing the hysteresis characteristic of a displacement and improving the linearity of a displacement trace can be provided. By reducing the hysteresis characteristic of the sensor using a magnetostrictive element, a contribution can be made to an improvement in measurement accuracy.

### BRIEF DESCRIPTION OF THE DRAWINGS

FIG. 1 is a longitudinal sectional view showing an actuator in this embodiment;

FIG. 2 is a view of a cross section taken along the A-A line shown by the arrow in FIG. 1;

FIG. 3 is a view explaining a magnetic field applied by an electromagnetic coil of the actuator in this embodiment;

FIG. 4 is a view explaining a magnetic field applied by a polar-anisotropic cylindrical magnet of the actuator in this embodiment;

FIG. 5 is a longitudinal sectional view showing the actuator in another embodiment;

FIG. 6 is a longitudinal sectional view showing a sensor in this embodiment;

FIG. 7 is a view of a cross section taken along the B-B line shown by the arrow in FIG. 6;

FIG. 8 is a view explaining a magnetic field applied by the polar-anisotropic cylindrical magnet of the sensor in this embodiment;

FIG. 9 is a longitudinal sectional view showing the sensor in another embodiment;

FIG. 10 is a graph showing a relation between an applied magnetic field and a magnetostrictive value in the actuator of the present invention;

FIG. 11 is a graph showing a relation between an applied magnetic field and a magnetostrictive value in the comparative actuator;

FIG. 12 is a graph showing a relation between a ratio of a value of deviation (b) of the magnetostrictive value in a predetermined applied magnetic field to the total magnetostrictive value and the applied magnetic field;

FIG. 13 is a graph showing a relation between a hysteresis value of the magnetostrictive value and the applied magnetic field;

FIG. 14 is a graph showing a change in inductance with pressure in a magnetostrictive sensor of the present invention;

FIG. 15 is a graph showing a change in inductance with pressure in the comparative magnetostrictive sensor;

FIG. 16 is a graph showing a relation between a ratio of a value of deviation (b) of the inductance at a predetermined pressure to the total amount of change (a) in inductance and the pressure; and

FIG. 17 is a graph showing a relation between the hysteresis value of the inductance and the pressure.

### DETAILED DESCRIPTION OF THE PREFERRED EMBODIMENTS

The present invention will be described below based on the embodiments shown in the accompanying drawings.

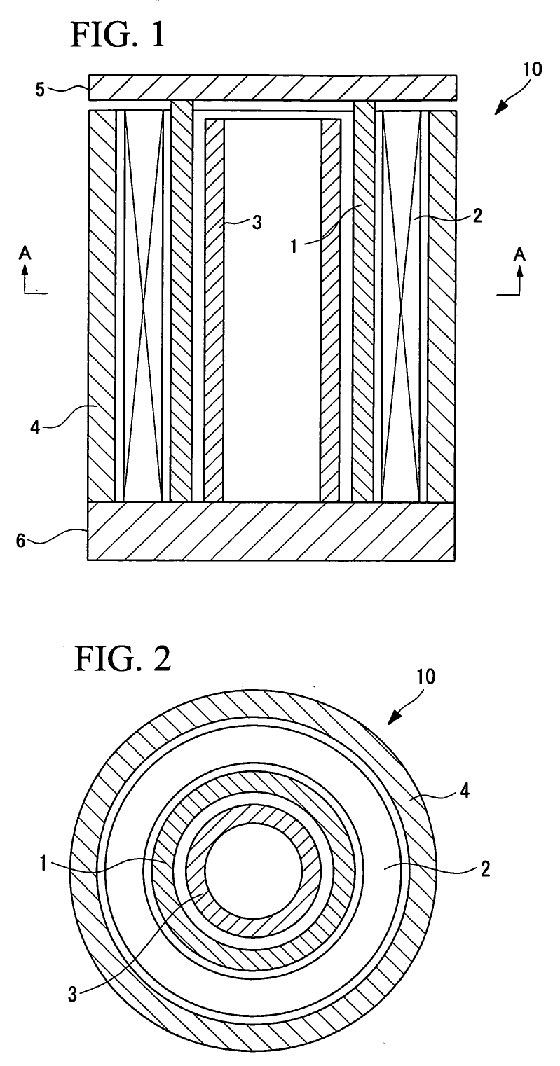

FIG. 1 is a longitudinal sectional view of an actuator 10 in this embodiment, and FIG. 2 is a view of a cross section taken along the A-A line shown by the arrow in FIG. 1.

The actuator 10 comprises a magnetostrictive element 1, an electromagnetic coil 2 and a polar-anisotropic cylindrical magnet 3.

The magnetostrictive element 1 is cylindrical, and linearly expands and contracts in the axial direction by an amount corresponding to the strength of a magnetic field when a magnetic field parallel to its axial direction (first magnetic field or driving magnetic field) is applied thereto. The magnetostrictive element returns to a state before the application of the magnetic field when the application of the magnetic field is cancelled.

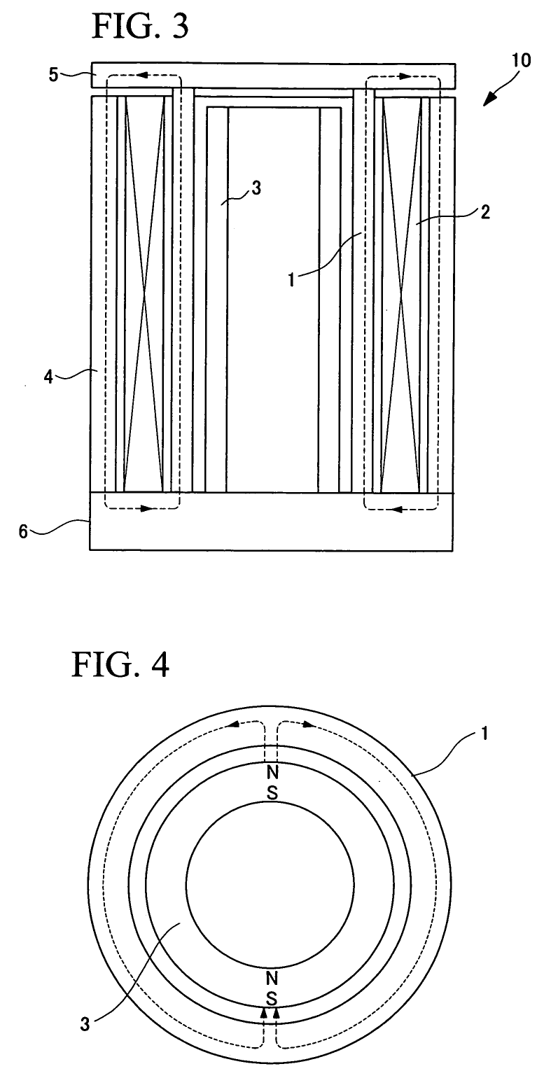

The electromagnetic coil 2 placed around the cylindrical magnetostrictive element 1 applies to the magnetostrictive element 1 a magnetic field parallel to its axial direction (first magnetic field or driving magnetic field) as shown by dotted lines in FIG. 3. The magnetostrictive element 1 and the electromagnetic coil 2 are coaxially placed. The electromagnetic coil 2 is supplied with a predetermined current from a power source (not shown), and the first magnetic field or driving magnetic field having a strength corresponding to the current is applied to the magnetostrictive element 1.

The polar-anisotropic cylindrical magnet 3 placed coaxially with the magnetostrictive element 1 in a hollow portion of the cylindrical magnetostrictive element 1 generates a second magnetic field or bias magnetic field. The second magnetic field or bias magnetic field is oriented in the peripheral direction of the magnetostrictive element I as shown by dotted lines in FIG. 4. It can be understood from FIGS. 3 and 4 that the second magnetic field or bias magnetic field crosses, or more specifically orthogonally crosses the first magnetic field or driving magnetic field generated from the electromagnetic coil 2. By applying the second magnetic field or bias magnetic field to the magnetostrictive element 1, a hysteresis characteristic of a magnetostrictive value in the process of expansion or contraction of the magnetostrictive element 1 can be reduced as described later.

The actuator 10 comprises an upper yoke 5 and a lower yoke 6. The upper yoke 5 is fixed at the upper end of the magnetostrictive element 1, and the lower yoke 6 is fixed at the lower end. On the lower yoke 6 are fixed the electromagnetic coil 2 and the polar-anisotropic cylindrical magnet 3, and a casing 4 composed of a ferromagnetic material, which is situated around the electromagnetic coil 2. In the actuator 10, the expansion or contraction of the magnetostrictive element 1 is output as a displacement of the upper yoke 5. Thus, the upper yoke 5 functions as an output end of the displacement.

A sintered body having composition expressed by RT_{y} (R represents one or more rare earth metals, T represents one or more transition metals, and y satisfies the requirement of 1<y<4) is preferably used as the magnetostrictive element 1 in this embodiment.

R represents one or more metals selected from the group consisting of rare earth metals of the lanthanoid series including Y and the actinoid series. As R, among them, rare earth metals such as Nd, Pr, Sm, Tb, Dy and Ho are particularly preferable, Tb and Dy are further preferable, and these metals may be used in combination. T represents one or more transition metals. As T, among them, transition metals such as Fe, Co, Ni, Mn, Cr and Mo are particularly preferable, Fe, Co and Ni are further preferable, and these metals may be used in combination.

An RT₂ Laves type intermetallic compound formed by R and T when y equals 2 in the composition formula RT_{y} is most suitable as the magnetostrictive element 1 because of its high Curie temperature and high magnetostrictive value. If y is 1 or less, an RT phase is precipitated with a heat treatment after sintering and the magnetostrictive value decreases. If y is 4 or more, an RT₃ or RT₅ phase increases, and the magnetostrictive value decreases. Thus, for increasing an RT₂ phase, the range of 1<y<4 is preferable. As R, a plurality of rare earth metals may be used, and particularly Tb and Dy are preferably used. If Tb and Dy are used as R, a high saturated magnetostriction constant and hence a high magnetostrictive value can be obtained by making the rare earth metal have a composition expressed by (TbₐDy₍₁₋ₐ₎)T_{y}. If a is 0.27 or less, a sufficient magnetostrictive value is not obtained at room temperature or lower, and if a exceeds 0.50, a sufficient magnetostrictive value is not obtained at around room temperature. T is particularly preferably Fe, and Fe forms a (Tb, Dy) Fe₂ type intermetallic compound with Tb and Dy, whereby a sintered body having a high magnetostrictive value and hence a high magnetostriction characteristic is obtained. At this time, part of Fe may be substituted by Co and/or Ni, but Co increases magnetic anisotropy but decreases a permeability, and Ni decreases the Curie temperature, and resultantly reduces a magnetostrictive value at room temperature and at a high magnetic field, and therefore the content of Fe is preferably 70 wt % or more, further preferably 80 wt % or more.

As the polar-anisotropic cylindrical magnet 3 in this embodiment, an Nd—Fe—B system sintered magnet having high magnetic properties is preferably used. Preferably, this sintered magnet has a composition of Nd: 20 to 40 wt %, B: 0.5 to 4.5 wt % and Fe: balance. If the amount of Nd is less than 20 wt %, an R₂Fe₁₄B phase being amain phase of the Nd—Fe—B system sintered magnet is not sufficiently produced, α-Fe and the like having soft magnetism are thus precipitated, and the coercive force is greatly reduced. If the amount of Nd exceeds 40 wt %, the volume ratio of the R₂Fe₁₄B phase as main phase decreases, and the residual magnetic flux density decreases. Since Nd reacts with oxygen, the amount of incorporated oxygen increases, and an Nd-rich phase effective for generation of the coercive force accordingly decreases, resulting in a reduction in coercive force, the amount of Nd is preferably 20 to 40 wt %. Part of Nd may be substituted by one or more of La, Ce, Pr, Nd, Sm, Eu, Gd, Tb, Dy, Ho, Er, Yb, Lu and Y.

If the amount of boron B is less than 0.5 wt %, a high coercive force cannot be obtained. However, if the amount of boron B exceeds 4.5 wt %, the residual magnetic flux density tends to decrease. Therefore, the upper limit should be set at 4.5 wt %. A desired range of boron B is from 0.5 to 1.5 wt %.

Further, M may be added to form an Nd—Fe—B-M system sintered magnet. As M, one or more of elements such as Co, Al, Cr, Mn, Mg, Si, Cu, C, Nb, Sn, W, V, Zr, Ti, Mo, Bi, Ag and Ga may be added.

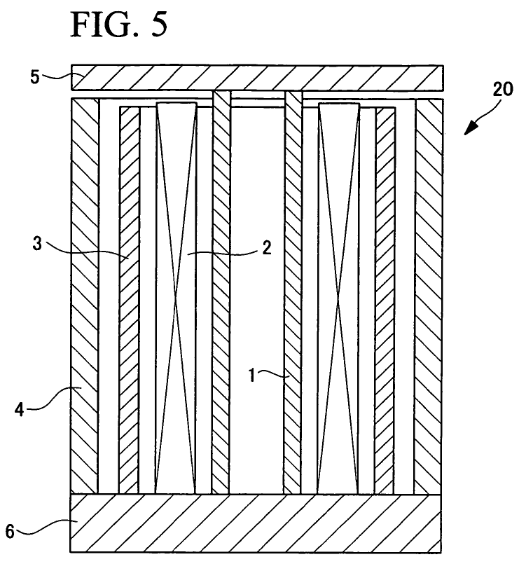

The actuator 10 described above has a configuration in which the electromagnetic coil 2 is placed around the magnetostrictive element 1, and the polar-anisotropic cylindrical magnet 3 is placed in the hollow portion of the magnetostrictive element 1, but the present invention is not limited to this configuration. For example, the actuator of the present invention may be an actuator 20 having a configuration in which the electromagnetic coil 2 is placed on the periphery side of the magnetostrictive element 1, and further the polar-anisotropic cylindrical magnet 3 is placed on the outer surface side of the electromagnetic coil 2, as shown in FIG. 5. In FIG. 5, components same as those of the actuator 10 are given same symbols.

The actuator 10 uses a magnet having 2 poles as the polar-anisotropic cylindrical magnet 3, but it may use a polar-anisotropic cylindrical magnet of which the number of poles is more than 2.

The actuator 10 uses the polar-anisotropic cylindrical magnet 3 as means for applying the second magnetic field or bias magnetic field to the magnetostrictive element 1, but it may use a radial anisotropy cylindrical magnet.

The actuators 10, 20 have a desirable configuration of the present invention, but the configuration may be appropriately changed within the scope of not being contradictory to the spirit of the present invention as a matter of course.

An example of applying the present invention to a sensor will now be described.

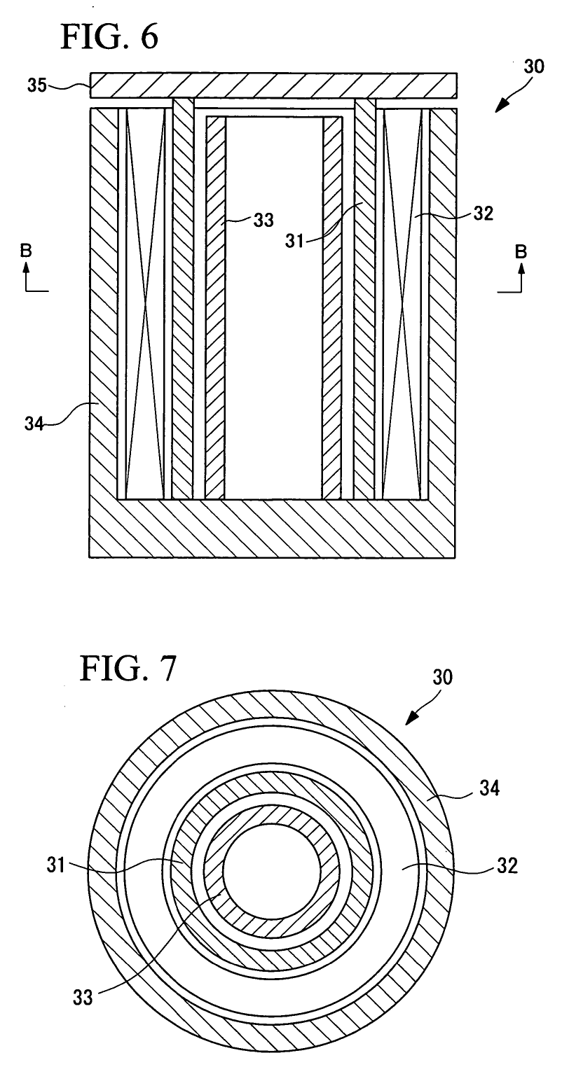

FIG. 6 is a longitudinal sectional view of a magnetostrictive sensor 30 in this embodiment, and FIG. 7 is a view of a cross section taken along the B-B line shown by the arrow in FIG. 6.

The magnetostrictive sensor 30 comprises a magnetostrictive element 31, a detection coil 32 and a polar-anisotropic cylindrical magnet 33.

If a pressure is externally applied to the cylindrical magnetostrictive element 31 in its axial direction, its permeability is changed according to the pressure. If a compressive stress is applied to the magnetostrictive element 31, its permeability decreases, and if a tensile stress is applied, its permeability increases. A composition preferable as the magnetostrictive element 31 is the composition described above.

Around the cylindrical magnetostrictive element 31, the detection coil 32 is placed coaxially with the magnetostrictive element 31. Therefore, if the magnetostrictive element 31 receives a pressure in its axial direction and its permeability is changed, the inductance of the detection coil 32 is changed. Namely, the magnetostrictive sensor 30 can detect a pressure by measuring a change in permeability of the magnetostrictive element 31 caused by an external pressure as a change in inductance generated in the detection coil 32.

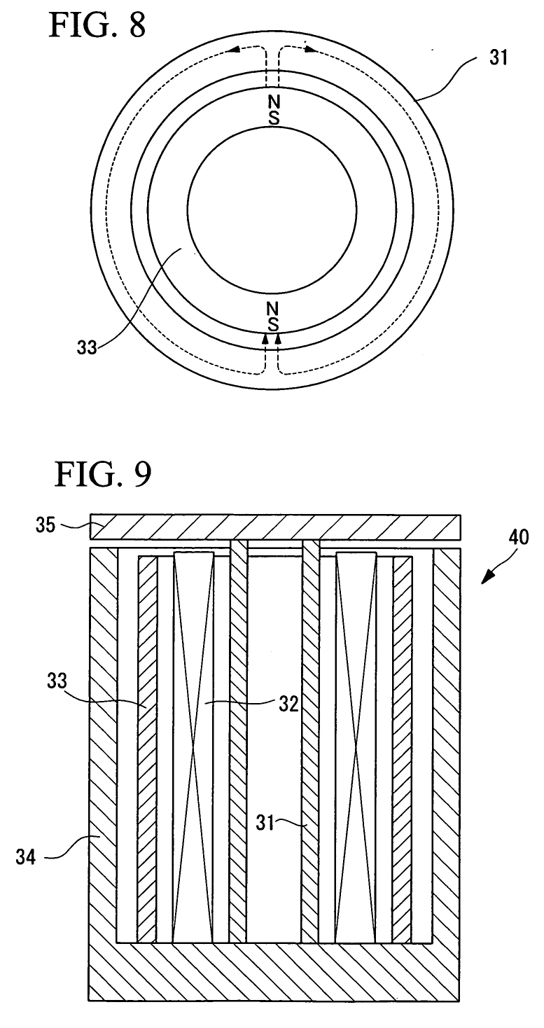

In the hollow portion of the cylindrical magnetostrictive element 31, the polar-anisotropic cylindrical magnet 33 is placed coaxially with the magnetostrictive element 31. As shown in FIG. 8, the polar-anisotropic cylindrical magnet 33 applies a bias magnetic field to the magnetostrictive element 31 in its peripheral direction. This bias magnetic field crosses, or more specifically orthogonally crosses the direction of expansion or contraction of the magnetostrictive element 31. By applying the bias magnetic field to the magnetostrictive element 31, the hysteresis characteristic of an inductance in the process of expansion or contraction of the magnetostrictive element 31 can be reduced as described latter.

The magnetostrictive sensor 30 comprises a casing 34 composed of a ferromagnetic material, and a pressure receiver 35. The cup-shaped casing 34 contains the magnetostrictive element 31, the detection coil 32 and the polar-anisotropic cylindrical magnet 33. The pressure receiver 35 is fixed at the upper end of the magnetostrictive element 31. The pressure receiver 35 receives an external pressure and the magnetostrictive element 31 expands and contracts, whereby the magnetostrictive sensor 30 changes its permeability, and the external pressure can be measured by a change in inductance of the detection coil 32 based on the change in permeability.

The magnetostrictive sensor 30 described above has a configuration in which the detection coil 32 is placed around the magnetostrictive element 31, and the polar-anisotropic cylindrical magnet 33 is placed in the hollow portion of the magnetostrictive element 31, but the present invention is not limited to this configuration. For example, the magnetostrictive sensor of the present invention may be a magnetostrictive sensor 40 having a configuration in which the detection coil 32 is placed on the periphery side of the magnetostrictive element 31, and further the polar-anisotropic cylindrical magnet 33 is placed in the hollow portion of the detection coil 32, as shown in FIG. 9. In FIG. 9, components same as those of the magnetostrictive sensor 30 are given same symbols.

The magnetostrictive sensor 30 uses a magnet having 2 poles as the polar-anisotropic cylindrical magnet 33, but it may use a polar-anisotropic cylindrical magnet of which the number of poles is more than 2.

The magnetostrictive sensor 30 uses the polar-anisotropic cylindrical magnet 33 as means for applying a bias magnetic field to the magnetostrictive element 31, but it may use a radial anisotropy cylindrical magnet.

The magnetostrictive sensors 30, 40 have a desirable configuration of the present invention, but the configuration may be appropriately changed within the scope of not being contradictory to the spirit of the present invention as a matter of course.

### EXAMPLE 1

An actuator (actuator of the present invention) having a configuration similar to that of the actuator 10 was fabricated using PMT-1 (trade name) manufactured by TDK Corporation as a material of the magnetostrictive element 1 and using NEOREC 42H (trade name) manufactured by TDK Corporation as a material of the polar-anisotropic cylindrical magnets 3. PMT-1 is a giant magnetostrictive material composed of a sintered body having a composition of Tb_{0.34}Dy_{0.66}Fe_{1.8}. NROREC 42H is an Nd—Fe—B system sintered magnet having a property of a coercive force (HcJ) 1500 kA/m and a residual magnetic flux density (Br) of 1350 mT.

The magnetostrictive element 1 has a dimension of an outer diameter of 6 mm, an inner diameter of 4 mm and a length of 20 mm, and the polar-anisotropic cylindrical magnet 3 has a dimension of an outer diameter of 3.8 mm, an inner diameter of 2 mm and a length of 18 mm.

For comparison, an actuator (comparative actuator) having a configuration same as that of the actuator 10 was fabricated except that the polar-anisotropic cylindrical magnet 3 was not provided.

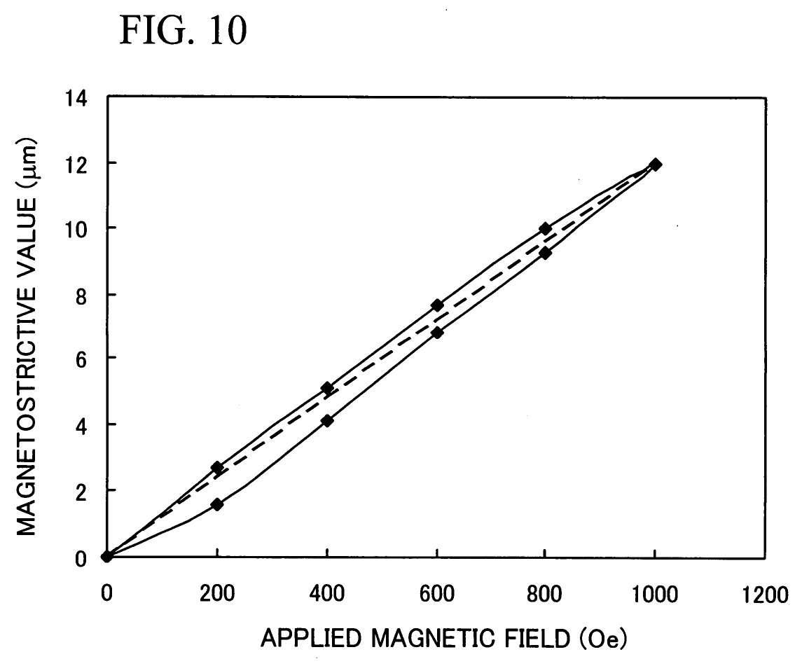

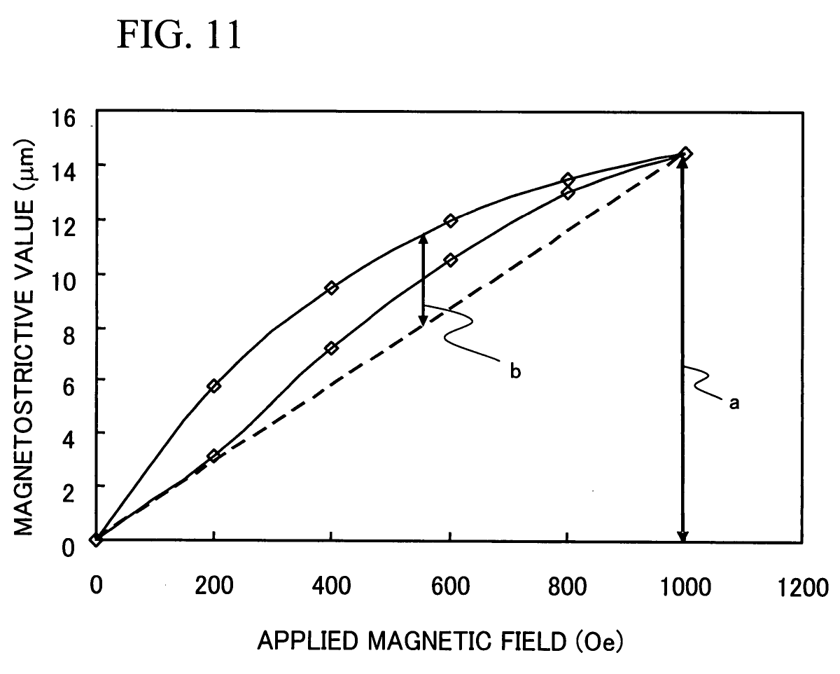

Using the actuator of the present invention and the comparative actuator, a relation between an applied magnetic field and a magnetostrictive value was measured. The results are shown in FIG. 10 (actuator of the present invention) and FIG. 11 (comparative actuator).

Then, the linearity of the magnetostrictive value and the hysteresis value were determined from the measurement results shown in FIGS. 10 and 11.

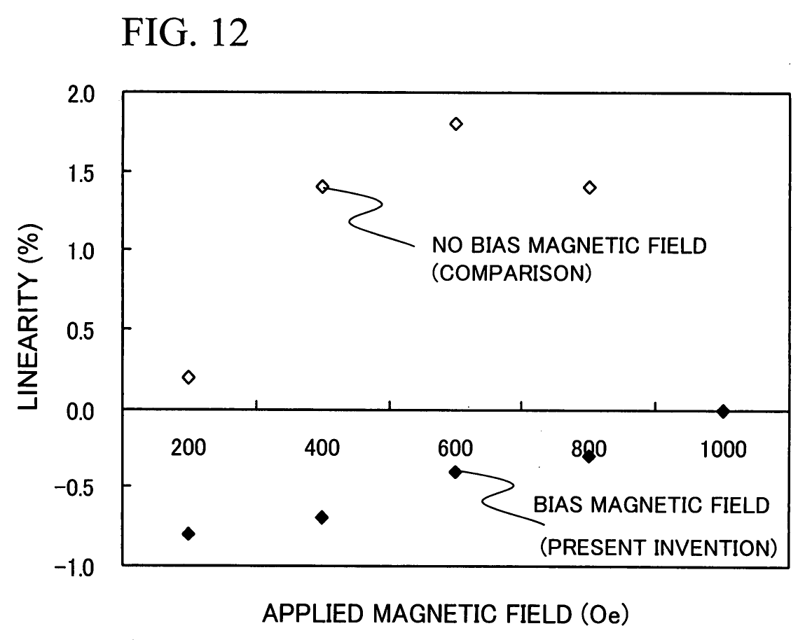

Ideally, the magnetostrictive value should change in a straight line (lineally) as shown by dotted lines in FIGS. 10 and 11. Then, a degree of deviation of the actual magnetostrictive value from the straight line was determined as the linearity. Specifically, as shown in FIG. 11, a ratio of a value of deviation (b) of the magnetostrictive value in a predetermined applied magnetic field to the total amount of change (a) in magnetostrictive value (b/a×100) was determined to be the linearity. The results are shown in FIG. 12.

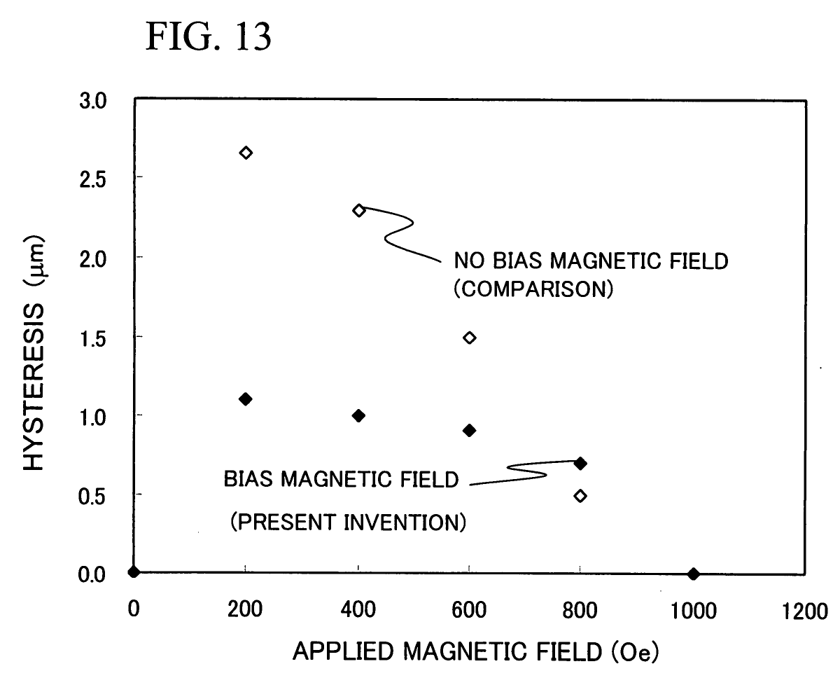

A difference between the magnetostrictive value when the magnetic field increased and the magnetostrictive value when the magnetic field decreased in a predetermined applied magnetic field was determined as a hysteresis value. The results are shown in FIG. 13.

As shown in FIGS. 12 and 13, for both the magnetostrictive actuator of the present invention and comparative magnetostrictive actuator, a hysteresis characteristic is present in the magnetostrictive value by a change in applied magnetic field. However, as shown in FIGS. 12 and 13, it can be understood that the magnetostrictive actuator of the present invention is improved in linearity of a change in magnetostrictive value and has a reduced hysteresis characteristic, compared with the comparative magnetostrictive actuator.

### EXAMPLE 2

A magnetostrictive sensor (magnetostrictive sensor of the present invention) having a configuration similar to that of the magnetostrictive sensor 30 was fabricated using PMT-1 (trade name) manufactured by TDK Corporation as a material of the magnetostrictive element 31 and using NEOREC 42H (trade name) manufactured by TDK Corporation as a material of the polar-anisotropic cylindrical magnets 33. PMT-1 is a giant magnetostrictive material composed of a sintered body having a composition of Tb_{0.34}Dy_{0.66}Fe_{1.8}. NEOREC 42H is an Nd—Fe—B system sintered magnet having a property of a coercive force (HcJ) 1500 kA/m and a residual magnetic flux density (Br) of 1350 mT.

The magnetostrictive element 1 has a dimension of an outer diameter of 6 mm, an inner diameter of 4 mm and a length of 8 mm, and the polar-anisotropic cylindrical magnet 33 has a dimension of an outer diameter of 3.8 mm, an inner diameter of 2 mm and a length of 7 mm.

For comparison, a magnetostrictive sensor (comparative magnetostrictive sensor) having a configuration same as that of the magnetostrictive sensor 30 was fabricated except that the polar-anisotropic cylindrical magnet 33 was not provided.

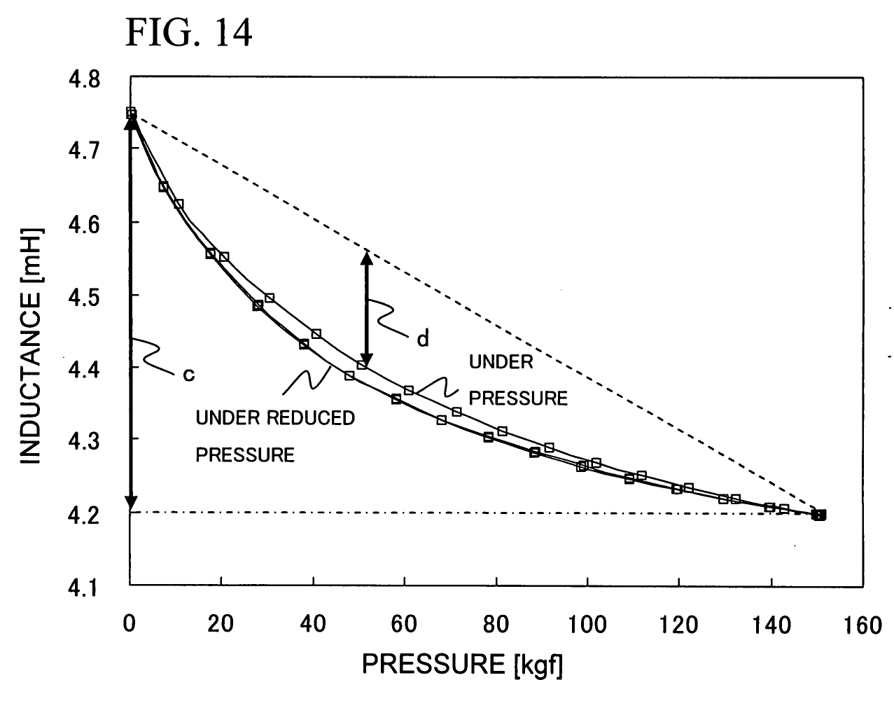

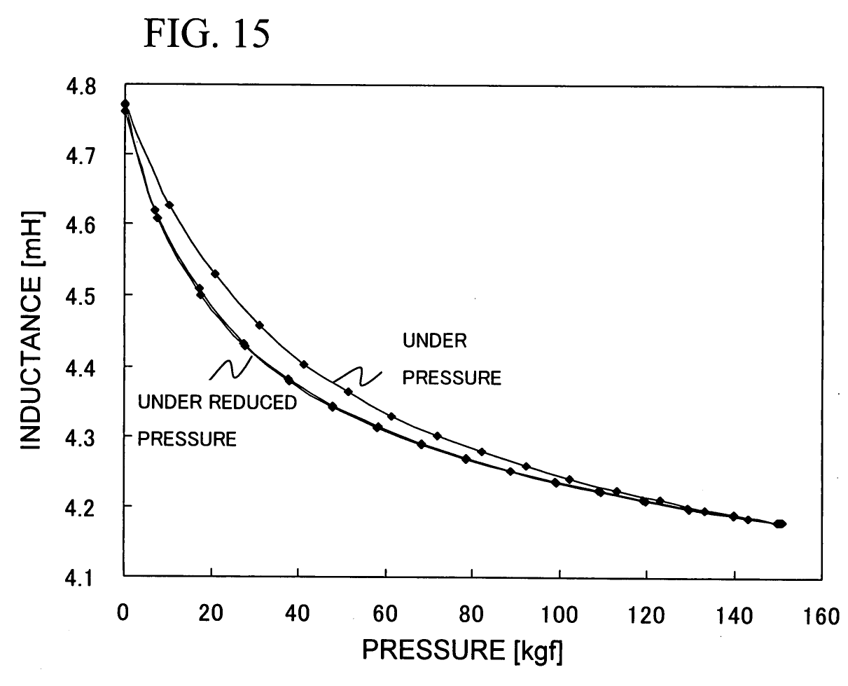

A change in inductance with pressure was measured using the magnetostrictive sensor of the present invention and the comparative magnetostrictive sensor. For the measurement, an alternating-current magnetic field of about 300 AT/m at 1 kHz was applied by an LCR meter. The results are shown in FIG. 14 (magnetostrictive sensor of the present invention and FIG. 15 (comparative magnetostrictive sensor).

Then, the linearity of a change in inductance and the hysteresis value were determined from the measurement results shown in FIGS. 14 and 15.

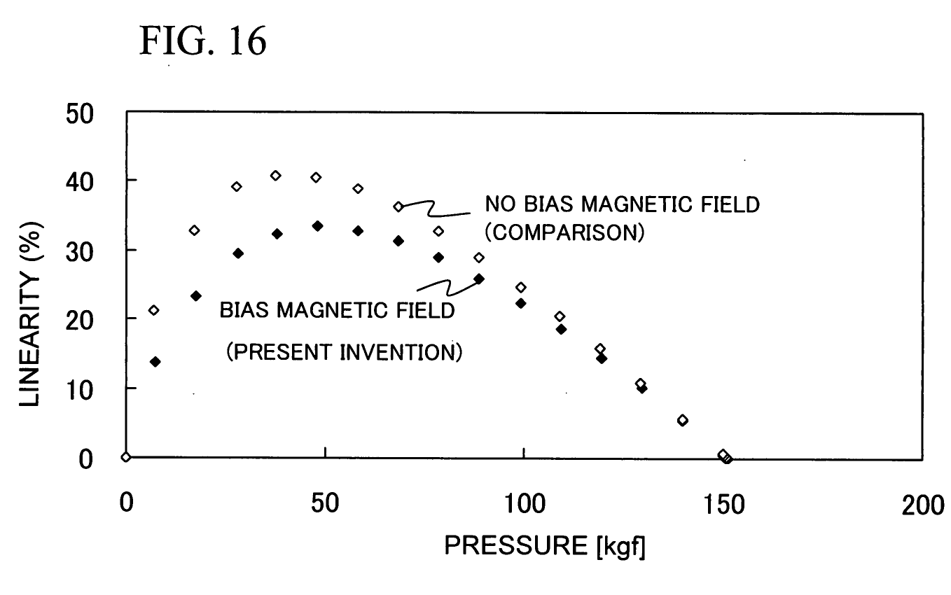

Ideally, the Indactance value changes in a straight line (lineally) as shown by dotted lines in FIG. 14. Then, a degree of deviation of the actual inductance from the straight line was determined as the linearity. Specifically, as shown in FIG. 14, a ratio of a value of deviation (d) of the inductance at a predetermined pressure to the total amount of change (c) in inductance (d/c×100) was determined to be the linearity. The results are shown in FIG. 16.

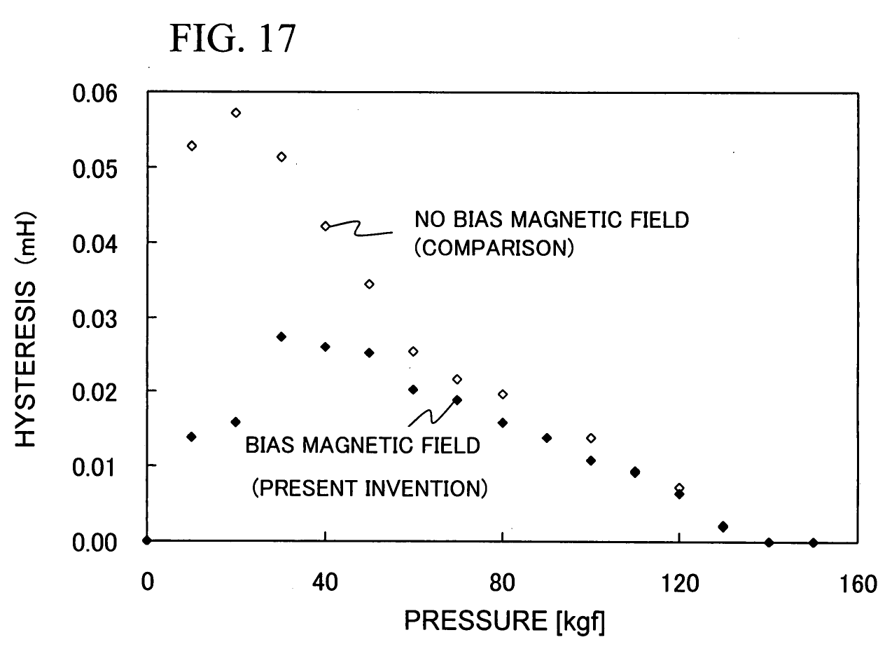

A difference between the inductance under pressure and the inductance under reduced pressure at a predetermined pressure was determined as a hysteresis value. The results are shown in FIGS. 16 and 17.

As shown in FIGS. 16 and 17, for both the magnetostrictive sensor of the present invention and comparative magnetostrictive sensor, a hysteresis characteristic is present in the value of inductance by a change in pressure. However, as shown in FIGS. 16 and 17, it can be understood that the magnetostrictive sensor of the present invention applying a bias magnetic field to the magnetostrictive element 1 is improved in linearity of a change in inductance and has a reduced hysteresis characteristic, compared with the comparative magnetostrictive sensor.

What is claimed is:

1. A magnetostrictive device comprising:
a magnetostrictive element expanding or contracting in the axial direction by application of a magnetic field or an external pressure;
a coil for applying said magnetic field or detecting a change in permeability of said magnetostrictive element according to said expansion or contraction; and
magnetic field applying means for applying a magnetic field in a direction crossing said direction of expansion or contraction of said magnetostrictive element.

2. The magnetostrictive device according to claim 1, wherein:
said magnetostrictive element is composed of a cylindrical body having a hollow portion,
said coil is placed coaxially with said cylindrical body, and
said magnetic field applying means is composed of a cylindrical permanent magnet placed coaxially with said cylindrical body.

3. The magnetostrictive device according to claim 2, wherein:
said coil is placed around said cylindrical body, and said cylindrical permanent magnet is placed in the hollow portion of said cylindrical body.

4. The magnetostrictive device according to claim 3, wherein:
said cylindrical permanent magnet is a polar-anisotropic permanent magnet.

5. The magnetostrictive device according to claim 1, wherein said magnetostrictive device is an actuator, and comprises:
said magnetostrictive element expanding or contracting in said axial direction by application of a first magnetic field in a direction parallel to said axial direction;
first magnetic field applying means composed of a coil for applying said first magnetic field to said magnetostrictive element; and
second magnetic field applying means for applying a second magnetic field in a direction crossing said first magnetic field to said magnetostrictive element.

6. The magnetostrictive device according to claim 5, wherein:
said first magnetic field and said second magnetic field substantially orthogonally cross each other.

7. The magnetostrictive device according to claim 5, comprising:
a casing containing said magnetostrictive element, said first magnetic field applying means and said second magnetic field applying means and composed of a ferromagnetic material; and
an output end portion for outputting a magnetostriction displacement of said magnetostrictive element and composed of a ferromagnetic material.

8. The magnetostrictive device according to claim 1, wherein said magnetostrictive device is a sensor, and comprises:
said magnetostrictive element expanding or contracting in said axial direction by receiving a pressure in said axial direction;
said coil for detecting a change in permeability of said magnetostrictive element according to said expansion or contraction; and
said magnetic field applying means for applying a magnetic field in a direction crossing said direction of expansion or contraction of said magnetostrictive element to said magnetostrictive element.

9. The magnetostrictive device according to claim 8, wherein said direction of expansion or contraction and said magnetic field applied by said magnetic field applying means substantially orthogonally cross each other.

10. The magnetostrictive device according to claim 8, comprising:
a casing containing said magnetostrictive element, said coil and said magnetic field applying means and composed of a ferromagnetic material; and
a pressure receiving portion given said pressure and composed of a ferromagnetic material.

11. The magnetostrictive device according to claim 1, wherein said magnetostrictive element is composed of a sintered body having a composition expressed by RT_{y} (R represents one or more rare earth metals, T represents one or more transition metals, and y satisfies the requirement of 1<y<4), and said cylindrical permanent magnet is composed of an Nd—Fe—B system sintered magnet.

12. An actuator comprising:
a cylindrical magnetostrictive element expanding or contracting in the axial direction by application of a driving magnetic field;
an electromagnetic coil placed on the outer surface side of said magnetostrictive element and for applying said driving magnetic field; and
a polar-anisotropic cylindrical permanent magnet placed on the inner surface side of said magnetostrictive element and for applying a magnetic field to said magnetostrictive element.

13. The actuator according to claim 12, wherein said polar-anisotropic cylindrical permanent magnet applies a bias magnetic field to said magnetostrictive element in its peripheral direction.

14. The actuator according to claim 13, wherein the hysteresis of magnetostrictive values in the process of said expansion or contraction is reduced by application of said bias magnetic field.

15. A sensor comprising:
a cylindrical magnetostrictive element expanding or contracting in the axial direction by receiving an external pressure;
a coil placed on the outer surface side of said magnetostrictive element and for detecting a change in permeability of said magnetostrictive element as a change in inductance; and
a polar-anisotropic cylindrical permanent magnet placed on the inner surface side of said magnetostrictive element and for applying a magnetic field to said magnetostrictive element.

16. The sensor according to claim 15, wherein said polar-anisotropic cylindrical permanent magnet applies a bias magnetic field to said magnetostrictive element in its peripheral direction.

17. The sensor according to claim 16, wherein the hysteresis of inductance values in the process of said expansion or contraction is reduced by application of said bias magnetic field.

18. A driving method of a magnetostrictive actuator, comprising the steps of:
(A) expanding or contracting a magnetostrictive element in the axial direction by applying a driving magnetic field to said magnetostrictive element in its axial direction; and
(B) applying a bias magnetic field substantially orthogonally crossing said driving magnetic field to said magnetostrictive element in said step (A).

19. A sensing method by a magnetostrictive sensor comprising the steps of:
(a) detecting a change in permeability of said magnetostrictive element by expansion or contraction of the magnetostrictive element in the axial direction; and
(b) applying a bias magnetic field substantially orthogonally crossing said direction of expansion or contraction to said magnetostrictive element in said step (a).
